(19) United States
(12) Patent Application Publication
(10) Pub. No.: US 2012/0073204 A1
(43) Pub. Date: Mar. 29, 2012

(54) SLIDING DOOR FOR AN ELEVATOR INSTALLATION

(76) Inventors: Bjarne Lindberg, Adligenswil (CH); Stefano Folli, Locarno (CH)

(21) Appl. No.: 13/248,695

(22) Filed: Sep. 29, 2011

(30) Foreign Application Priority Data
Sep. 29, 2010 (EP) 10181737.7

(51) Int. Cl. B66B 13/08

(52) U.S. Cl. 49/100; 49/506

(57) ABSTRACT

A sliding door for an elevator installation comprises door leaves, which are horizontally displaceable between a closed position and an open position. The sliding door further comprises a synchronization element, which is coupled with the door leaves and so synchronizes these that the door leaves are guided at different speeds in an opening direction from the closed position to the open position and conversely against the opening direction. The sliding door comprises a toggle mechanism which a couples a door post with only one door leaf, which is not directly arranged at the door post.

### CROSS-REFERENCE TO RELATED APPLICATION

This application claims priority to European Patent Application No. 10181737.7, filed Sep. 29, 2010, which is incorporated herein by reference.

### FIELD

The present disclosure relates to a sliding door for an elevator installation.

### BACKGROUND

Use is made in elevator installations of sliding doors not only as cage doors, but also shaft doors. Thus, EP 1 686 087 A1 describes a sliding door for use as a shaft door. This shaft door comprises several horizontally sliding door panels and a scissors linkage with several junction points, wherein the horizontally sliding door panels are synchronized by the scissors linkage. It is achieved by this synchronization that each door panel during an opening or closing process is set in motion at the same time and reaches its end position at the same time.

Sliding doors in elevator installations often have to be self-closing. Thus, shaft doors can often close by themselves when they are not coupled with a cage door. Open shaft accesses, which represent a significant risk for passengers, can thereby be prevented. In addition, sliding doors have to have a certain measure of stability. For example, a shaft door has to be able to withstand a nominal force, which is predefined in standards, in the direction of shaft. Neither a self-closing nor increased stability are achieved by shaft doors such as are disclosed in EP 1 686 087 A1.

### SUMMARY

At least some embodiments disclosed herein comprise a shaft door, which is self-closing and has an enhanced stability, for an elevator installation. In some cases the sliding door occupies as little space as possible and can be guided in simple mode and manner.

Particular embodiments comprise a sliding door with at least two door leaves and a synchronization element. In that case the door leaves are horizontally displaceable between a closed position and an open position. The synchronization element is coupled with the door leaves and so synchronizes these that the door leaves are guided at different speeds, which are constant relative to one another, in an opening direction from the closed position to the open position and conversely against the opening direction. The sliding door additionally comprises at least one toggle mechanism which couples a door post with only one door leaf, which is not directly arranged at the door post.

In further embodiments the toggle mechanism couples the door post with a fastest door leaf. This can mean that a stabilizing action of the toggle mechanism is effective at all door leaves. If, for example, the toggle mechanism is coupled with the second-fastest door leaf, then a play between the door post and the fastest door leaf is greater than if the fastest door leaf is directly coupled by way of the toggle mechanism with the door post.

In further embodiments the synchronization element comprises a first and a second toggle mechanism. Use of two toggle mechanisms can mean that the stability of the sliding door can be additionally increased, particularly if the first toggle mechanism is arranged in an upper region of the sliding door and the second toggle mechanism is arranged in a lower region of the sliding door.

In additional embodiments the first toggle mechanism and the second toggle mechanism are coupled together by a coupling rod. The stability of the sliding door is thereby additionally enhanced and a self-closing of the sliding door can be ensured by an appropriate intrinsic weight of the coupling rod.

Through this coupling the first and second toggle mechanisms together with coupling rod act like a parallelogram so that the door leaf, which is coupled with the toggle mechanisms, is held stably in its vertical position during the opening and closing. The other door leaves which are not directly coupled with the toggle mechanisms are supported by the synchronization element. Thus, all door leaves are supported by the two toggle mechanisms or the synchronization element and therefore merely have to be guided by a guide carriage, but not substantially supported. Such an arrangement with two toggle mechanisms connected by way of a coupling rod guarantees a high level of stability during the entire closing or opening process of the sliding door.

In further embodiments a joint of the toggle mechanism is arranged in an open state of the sliding door higher than in a closed state of the sliding door. A self-closing of the sliding door can thereby be guaranteed, because limbs of the toggle mechanism due to the intrinsic weight thereof on the one hand exert a force on the door post and on the other hand a force on the door leaf coupled with the toggle mechanism, so that the door leaf coupled with the toggle mechanism experiences a force in a closing direction of the sliding door.

In additional embodiments the synchronization element comprises at least one scissors linkage. In that case, each door leaf can be rotatably coupled with the scissors linkage at fulcra, wherein the scissors linkage can comprise a respective free joint between two fulcra. In an exemplifying form of embodiment the synchronization element comprises a second scissors linkage, wherein the first and second scissors linkages are arranged in mirror image to one another. In an exemplifying form of embodiment at least one scissors linkage is arranged in an upper region of the sliding door and a further scissors linkage in a lower region of the sliding door.

The stability of the sliding door can be further increased by a suitable combination of scissors linkages. In that case, scissors linkages in mirror image can also be combined to form a double-scissors. An uneven number of scissors linkages can also be used, so that not every scissors linkage has a counterpart in mirror image.

In further embodiments elements of the scissors linkages in a closed state of the sliding door have an angle of at least 30 degrees with the horizontal. The scissors linkages are thereby usually not strongly extended during the entire closing or opening process, which can have the consequence of increased stability.

In further embodiments the synchronization element comprises four scissors linkages, wherein two scissors linkages are arranged in an upper region of the sliding door and wherein two further scissors linkages are arranged in a lower region of the sliding door. A first upper scissors linkage and a second upper scissors linkage can be arranged in mirror image to one another and a first lower scissors linkage and a second lower scissors linkage can be similarly arranged in mirror image to one another. The scissors linkages are coupled together by the door leaves and/or by synchronization rods so that they execute an identical movement during opening or closing of the sliding door.

In further embodiments the toggle mechanism and the scissors linkage have at least one common fulcrum. In an exemplifying form of embodiment this common fulcrum is a drive shaft. As result, not only the toggle mechanism, but also the scissors linkage are directly driven by the drive, which can influence the mechanics of the synchronization element, since as a result at least two door leaves are driven by only one joint, for example the slowest and the fastest door leaf.

In alternative embodiments the toggle mechanism and the scissors linkage do not have a common fulcrum. The constructional depth of the synchronization element can thereby be reduced, because the toggle mechanism and the scissors linkage can then be arranged one above the other and not one behind the other.

In additional embodiments only one door leaf, possibly the fastest door leaf, is suspended by way of a guide apparatus at a guide rail. Such a minimum suspension of the door leaves is made possible in that a moment loading of the leaves of the door by way of the toggle mechanism is conducted at least partly into the door post. The door leaves thereby merely have to be guided by a guide apparatus in the form of a small support roller. It is not necessary for each door leaf to be supported by a guide carriage able to provide compensation for higher levels of loading by moments. This enables on the one hand use of economic and light guide mechanisms and on the other hand little constructional volume is demanded by guide apparatus merely in the form of a small support roller. This can be an advantage (e.g., in the case of modernization applications), because often little constructional volume is available.

The sliding door can be designed to be space-saving through the use of door leaves in conjunction with a synchronization element. This can apply, for example, when the width of the door leaves is kept as small as possible and the number of the door leaves is correspondingly high.

The synchronization element can be constructed as a scissors linkage. However, alternatively thereto further forms of embodiment are possible. For example, the synchronization element can be constructed as a rotatably attached beam which is respectively coupled by way of rollers with the individual door leaves. A further example for a synchronization element is a telescopic linkage which can be used with an appropriate translation, for example with the help of gearwheels, for the synchronization.

In some cases, through a suitable design of the synchronization elements a requisite stability of the sliding door is maintained during the entire opening and closing phase.

In some embodiments, the sliding door can be used for modernization of existing elevator installations. If, for example, shaft doors with rotatable door leaves are to be modernized, the sliding door can be mounted in simple mode and manner on existing door posts without a shaft door opening having to be enlarged or worked in another manner. In the case of modernization operations, work on masonry can be undesirable, because dust and noise are thereby created.

The existing door posts can, in some cases, accordingly serve as a mounting basis. A coupling to an entrainer of a cage door can be produced by a drive shaft which is guided through the existing door posts.

Further embodiments comprise a method for locking a sliding door for an elevator installation. The sliding door comprises at least two door leaves which are horizontally displaceable between a closed position and an open position. The sliding door further comprises a synchronization element. The synchronization element is coupled with the door leaves and so synchronizes these that the door leaves are guided at different speeds, which are constant relative to one another, in an opening direction from the closed position to the open position and conversely opposite to the opening direction. The sliding door further comprises at least one toggle mechanism. The method comprises the step of opening or closing the sliding door, wherein the toggle mechanism couples a door post with a door leaf which is not directly arranged at the door post.

### BRIEF DESCRIPTION OF THE DRAWINGS

Further details are described in the following on the basis of exemplifying embodiments and with reference to schematic drawings, in which:

FIG. 1A shows an exemplifying form of embodiment of a sliding door in perspective illustration;

FIG. 1B shows an exemplifying form of embodiment of a sliding door in sectional illustration;

FIG. 2A shows an exemplifying form of embodiment of a sliding door with a synchronization element and a toggle mechanism in closed position;

FIG. 2B shows an exemplifying form of embodiment of a sliding door with a synchronization element and a toggle mechanism in closed position;

FIG. 2C shows an exemplifying form of embodiment of a sliding door with a synchronization element and a toggle mechanism in half-open position;

FIG. 2D shows an exemplifying form of embodiment of a sliding door with a synchronization element and a toggle mechanism in opened position;

FIG. 3A shows an exemplifying form of embodiment of a sliding door with a synchronization element and a toggle mechanism in closed position;

FIG. 3B shows an exemplifying form of embodiment of a sliding door with a synchronization element and a toggle mechanism in closed position;

FIG. 3C shows an exemplifying form of embodiment of a sliding door with a synchronization element and a toggle mechanism in closed position; and

FIG. 3D shows an exemplifying form of embodiment of a sliding door with a synchronization element and a toggle mechanism in closed position.

### DETAILED DESCRIPTION

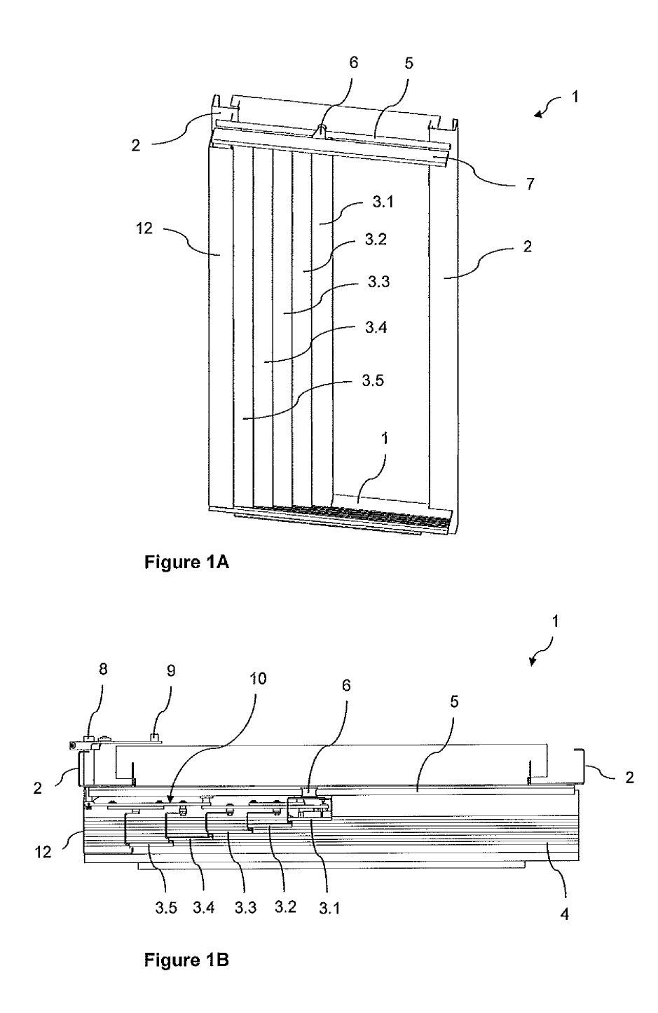

An exemplifying form of embodiment of a sliding door for an elevator installation is illustrated in FIGS. 1A and 1B. This sliding door is shown in perspective illustration in FIG. 1A and in sectional illustration in FIG. 1B. The sliding door 1 is arranged on a door frame 2. For the sake of better clarity only one door panel is illustrated. The door leaves 3.1, 3.2, 3.3, 3.4, 3.5 in that case form a door panel. The door leaves 3.1, 3.2, 3.3, 3.4, 3.5 are guided in a guide rail 4 disposed below the door leaves. A fastest door leaf 3.1 is suspended by way of a guide apparatus 6 at a guide rail 5. In that case a roller of the guide apparatus 6 runs on the guide rail 5. A lintel 7 closes off the door leaves 3.1, 3.2, 3.3, 3.4, 3.5 in upward direction.

The door leaves 3.1, 3.2, 3.3, 3.4, 3.5 can be so designed that they can nest in one another and in a door post 12. In that case the quickest door leaf 3.1 is formed to be thinnest and a slowest door leaf 3.5 is formed to be thickest.

A synchronization element 10 synchronizes a movement of the door leaves 3.1, 3.2, 3.3, 3.4, 3.5 during opening and during closing of the sliding door. In that case the synchronization element 10 is coupled to a drive shaft 8. The drive shaft 8 extends through the door frame 2 and is in turn coupled to a drive engagement 9. In the case of use as a shaft door the sliding door 1 can thereby be driven by way of an entrainer (not illustrated) of a cage door.

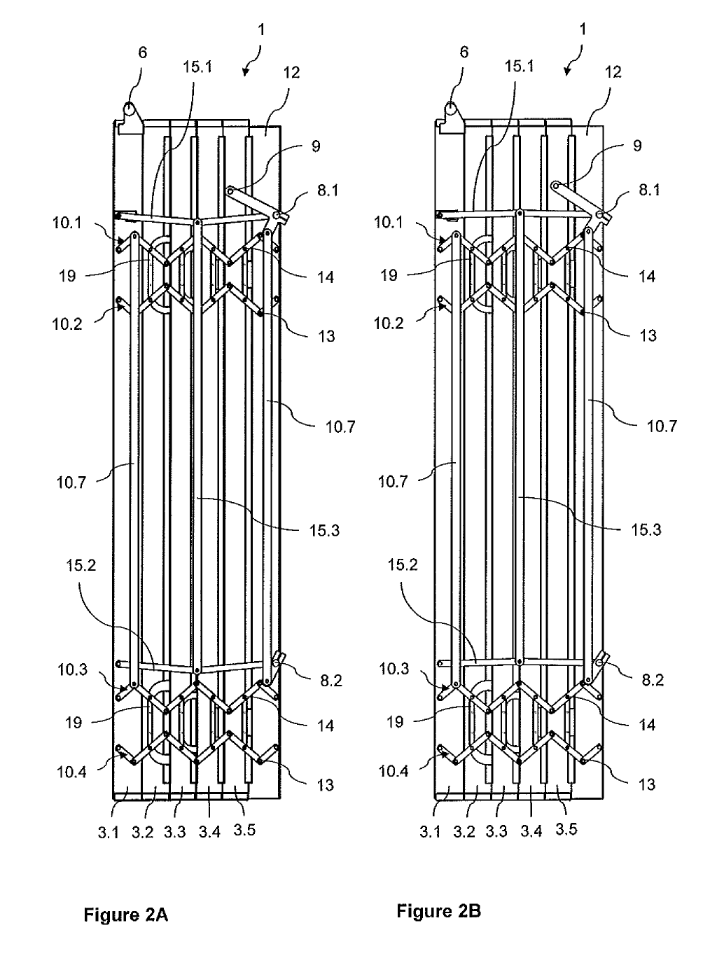

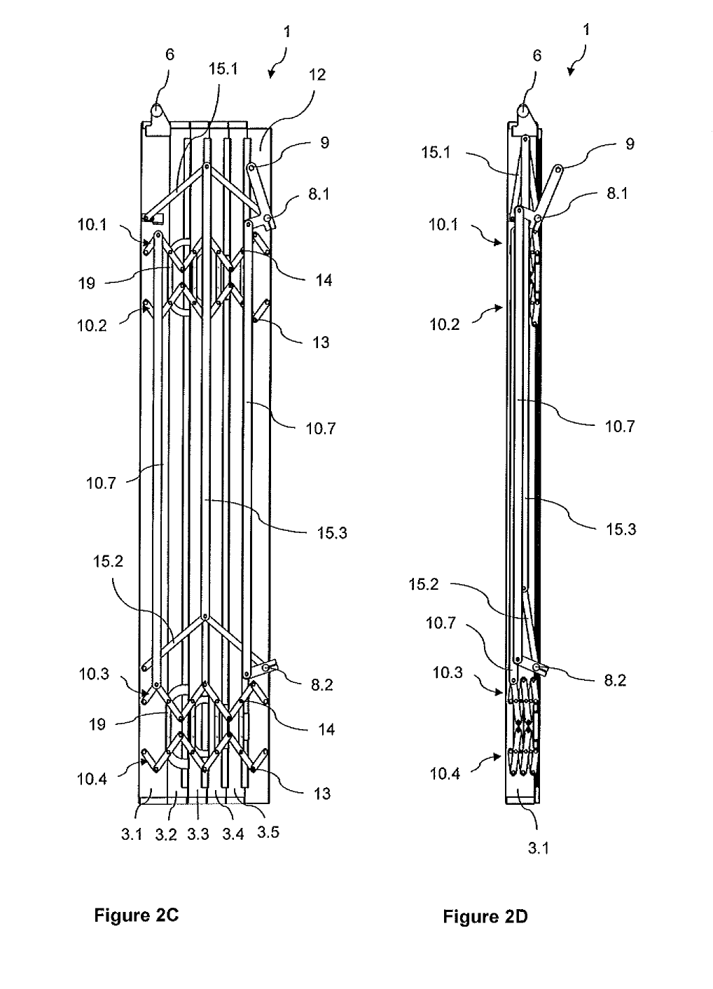

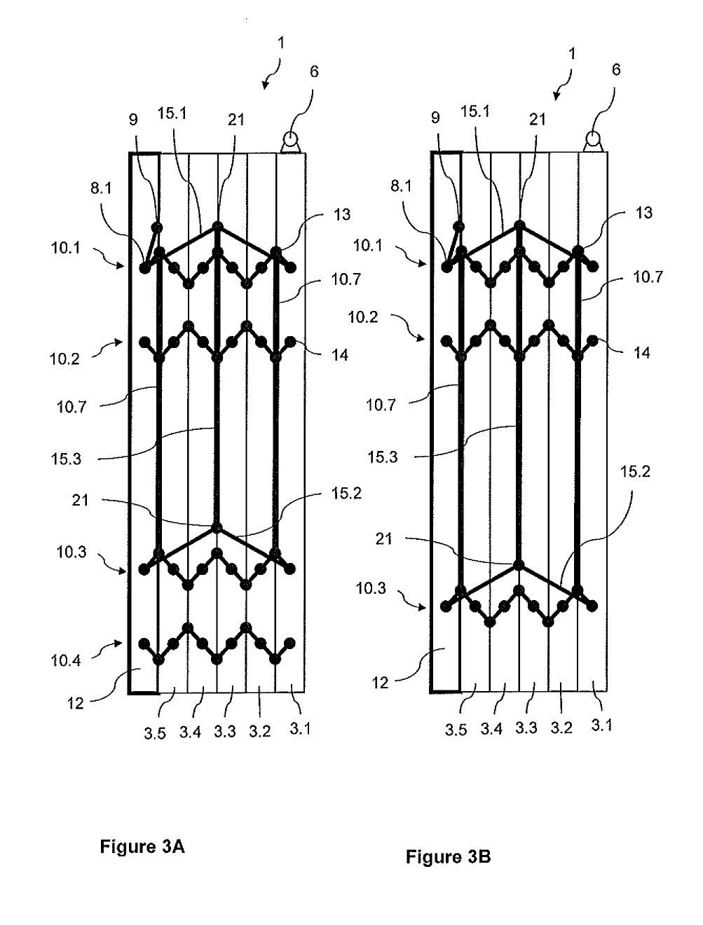

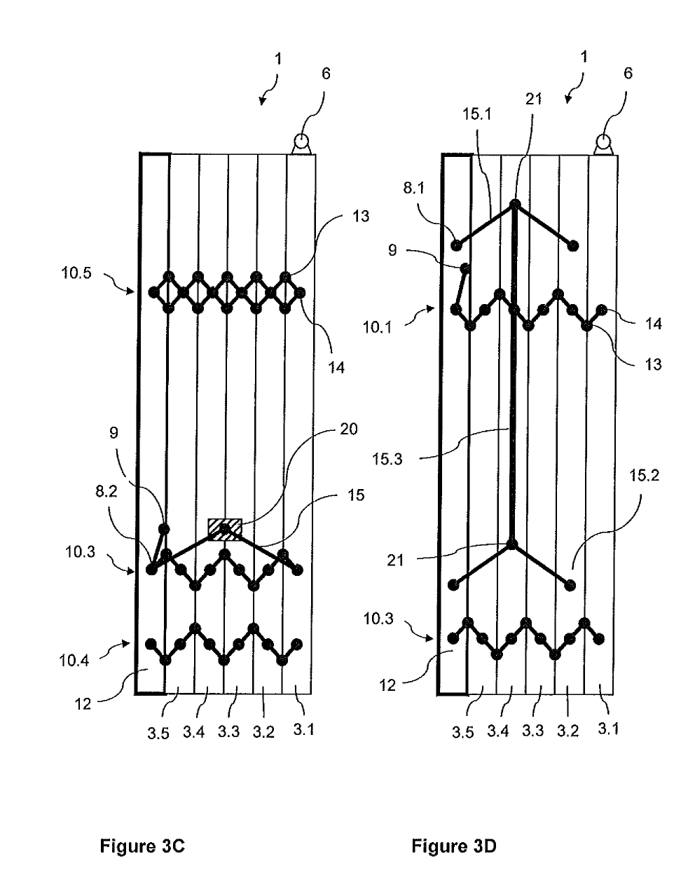

As illustrated in FIG. 1B the sliding door 1 can comprise a drive shaft 8. In an alternative form of embodiment the sliding door comprises an upper drive shaft 8.1 and a lower drive shaft 8.2, which are respectively coupled by upper and lower synchronization elements 10.1, 10.2, 10.3, 10.4. In FIGS. 2A to 3B and 3D in each instance only the upper drive shaft 8.1 is driven by way of the drive engagement 9. In an alternative form of embodiment as illustrated in FIG. 3C only the lower drive shaft 8.2 is driven. In a further alternative form of embodiment (not illustrated) not only the lower drive shaft 8.2, but also the upper drive shaft 8.1 are driven. In the following, to assist clarity merely the term drive shaft 8 is used.

The sliding door 1 illustrated in FIGS. 1A and 1B is constructed as a centrally opening sliding door with five door leaves 3.1, 3.2, 3.3, 3.4, 3.5 per door panel. In an alternative form of embodiment a sliding door has only one door leaf and/or more or less than five door leaves per door panel.

A sliding door 1 with a synchronization element is illustrated in FIGS. 2A to 2D, wherein the sliding door additionally comprises a toggle mechanism 15. In that case, FIGS. 2A to 2D each show an entire door leaf.

In this exemplifying embodiment the synchronization element 10 comprises four scissors linkages 10.1, 10.2, 10.3, 10.4. In that case, two upper scissors linkages 10.1 and 10.2 are arranged in an upper region of the sliding door 1 and two lower scissors linkages 10.3 and 10.4 are arranged in a lower region of the sliding door 1. A first upper scissors linkage 10.1 and a second upper scissors linkage 10.2 are then arranged in mirror image to one another and a first lower scissors linkage 10.3 and a second lower scissors linkage 10.4 are similarly arranged in mirror image to one another.

The scissors linkages 10.1, 10.2, 10.3, 10.4 are coupled together by the door leaves 3.1, 3.2, 3.3, 3.4, 3.5. Scissors linkages arranged in mirror image to one another thereby act like a double-scissors. In this arrangement, all four scissors linkages 10.1, 10.2, 10.3, 10.4 move synchronously with one another and impart enhanced stability to the sliding door 1.

In an alternative form of embodiment (not illustrated) the synchronization element 10 comprises one, two, three or more than four scissors linkages 10.1, 10.2, 10.3, 10.4. In that case, scissors linkages 10.1, 10.2, 10.3, 10.4 can be arranged at different heights. Use of scissors linkages 10.1, 10.2, 10.3, 10.4, which are arranged in mirror image to one another, at different heights improves the stability of the synchronization element 10.

The door leaves 3.1, 3.2, 3.3, 3.4, 3.5 are coupled with the scissors linkages 10.1, 10.2, 10.3, 10.4 by way of fulcra 14. In order to be able to gently transmit the forces which arise, reinforcing elements 19 can be provided at the door leaves 3.1, 3.2, .3.3, 3.4, 3.5. In this case the scissors linkages 10.1, 10.2, 10.3, 10.4 are coupled with the reinforcing elements 19, which are fixedly connected with the door leaves 3.1, 3.2, .3.3, 3.4, 3.5.

In the exemplifying embodiment shown in FIGS. 2A to 2D the toggle mechanism 15 additionally serves for locking the sliding door 1. The toggle mechanism 15 has two limbs, which are connected together by way of a joint. A first limb of the toggle mechanism 15 is coupled with the drive shaft 8 and drivable by this. A second limb of the toggle mechanism 15 is coupled with a door leaf 3.1, 3.2, .3.3, 3.4, 3.5, possibly the fastest door leaf 3.1. The toggle mechanism 15 is so dimensioned that the two limbs of the toggle mechanism 15 are fully extended when the sliding door 1 is closed.

The sliding door 1 is locked by an over-extension of the toggle mechanism 15. The toggle mechanism 15 is in that case possibly over-extended by only a few degrees so as to keep a thereby-caused opening of the sliding door as small as possible. In a form of embodiment an abutment is so arranged that the toggle mechanism 15 cannot be over-extended further than 10°, possibly not further than 5°. The abutment (not illustrated) can in that case be arranged at, for example, a door leaf 3.1, 3.2, .3.3, 3.4, 3.5. In an alternative form of embodiment the abutment is integrated in a joint of the toggle mechanism 15 so that the joint can be opened only as far as a desired opening angle.

The toggle mechanism 15 can be unlocked from the over-extended position by actuation of the drive shaft 8. Through actuation of the door leaves 3.1, 3.2, .3.3, 3.4, 3.5 in opening direction the toggle mechanism 15 can be moved out of the over-extended position, but not unlocked. An actuation of the drive shaft 8 can, for example, take place by displacement of the drive engagement 9. In that case, an entrainer, which is coupled with a drive of a cage door, typically engages in the drive engagement 9.

As illustrated in FIGS. 2A to 2D, a first toggle mechanism 15.1 and a second toggle mechanism 15.2 can be arranged. The first toggle mechanism 15.1 and the second toggle mechanism 15.2 are synchronized by way of a coupling rod 15.3. In this exemplifying embodiment only the first toggle mechanism 15.1 is drivable by the drive shaft 8. The first toggle mechanism 15.1 and the second toggle mechanism 15.2 each comprise two limbs and a joint, which rotatably connects together the two limbs.

An opening process is illustrated in FIGS. 2A to 2D. In that case, the locking mechanism comprising the toggle mechanism 15 in FIG. 2A is disposed in a locked state and in FIG. 2B in an unlocked state. In FIG. 2C the sliding door is half-open and the toggle mechanism 15 is disposed in an angled state. In FIG. 2D the sliding door is open. The drive engagement 9 is during the opening process displaced in clockwise sense about the drive shaft 8. An unlocking of the toggle mechanism 15 takes place with the door leaves 3.1, 3.2, .3.3, 3.4, 3.5 still substantially closed.

In FIGS. 2A to 2D the synchronization element 10 is coupled with the drive shaft 8. In an alternative form of embodiment, as illustrated in FIG. 3D, the synchronization element 10 is not coupled with the drive shaft 8. In this exemplifying embodiment a force for opening the sliding door 1 is transmitted from the drive shaft 8 via the toggle mechanism 15 to the fastest door leaf 3.1 and from there distributed by the synchronization element 10 to the other door leaves 3.1, 3.2, 3.3, 3.4, 3.5.

Alternative forms of embodiment of a sliding door 1 with a synchronization element 10 and a toggle mechanism 15 are illustrated in FIGS. 3A to 3D. It is apparent from the illustrated examples that not only the synchronization element 10, but also the toggle mechanism 15 can be constructed in different modes and manners. However, the invention is not restricted to the combinations and forms of embodiment illustrated in the figures.

FIG. 3A shows a sliding door 1 with a synchronization element 10 which consists of four scissors linkages 10.1, 10.2, 10.3, 10.4. In that case, two scissors mechanisms 10.1, 10.2 are arranged in an upper region of the sliding door 1 and in mirror image to one another. Two further scissors linkages 10.3, 10.4 are arranged in a lower region of the sliding door 1 and similarly in mirror image to one another. The toggle mechanism 15 in this exemplifying embodiment comprises a first toggle mechanism 15.1 and a second toggle mechanism 15.2, which are coupled together by a coupling rod 15.3. The toggle mechanisms 15.1 and 15.2 comprise a joint 21 which rotatably interconnects the two limbs of the toggle mechanisms 15.1, 15.2.

The first toggle mechanism 15.1 has two common fulcra 8, 14 with a first upper scissors linkage 10.1 and the second toggle mechanism 15.2 has two common fulcra 14 with a first lower scissors linkage 10.3. The toggle mechanism 15 is thereby directly coupled with two scissors linkages 10.1, 10.3 of the synchronization elements 10. A second upper scissors linkage 10.2 and a second lower scissors linkage 10.4 are respectively coupled by way of the door leaves 3.1, 3.2, 3.3, 3.4, 3.5 with the first upper scissors linkage 10.1, the first lower scissors linkage 10.3 and the toggle mechanism.

In this exemplifying embodiment a common fulcrum of the first toggle mechanism 15.1 forms together with the first upper scissors linkage 10.1 the drive shaft 8. The first toggle mechanism 15.1 and the first upper scissors linkage 10.1 are drivable by an entrainer of an elevator cage door motor by way of the drive engagement 9.

In particular embodiments, only the fastest door leaf 3.1 is supported by a guide apparatus 6, which is guided on a guide rail (not illustrated). The remaining door leaves 3.2, 3.3, 3.4, 3.5 are supported by the synchronization element 10 in co-operation with the toggle mechanism 15.

FIG. 3B shows a sliding door 1 similar to FIG. 3A. However, here the synchronization element 10 has in the lower region of the sliding door 1 only one scissors mechanism 10.3. Depending on the respective design of the sliding door 1 and the synchronization element 10 or the toggle mechanism 15, three scissors linkages 10.1, 10.2, 10.3 can suffice in order to impart sufficient stability to the door leaves 3.1, 3.2, 3.3, 3.4, 3.5.

FIG. 3C shows a further exemplifying form of embodiment of a sliding door 1. Here the toggle mechanism 15 consists of only one toggle mechanism, which is arranged in the lower region of the sliding door 1. In order to securely guarantee the self-closing function, an additional weight 20 is arranged in a joint of the toggle mechanism. Compensation for the self-closing effect of the missing coupling rod 15.3 and the missing second toggle lever 15.2 can thereby be provided in this exemplifying embodiment.

A double-scissors linkage 10.5 is arranged in the upper region of the sliding door 1 instead of two scissors linkages 10.1, 10.2. This double-scissors substantially takes over the same functions as two individual scissors linkages arranged in mirror image to one another.

The drive shaft 8 and the drive engagement 9 are arranged in the lower region of the sliding door 1, namely at the first lower scissors linkage 10.3 and the toggle mechanism 15.

FIG. 3D shows a further exemplifying form of embodiment of a sliding door 1. In this exemplifying embodiment the toggle mechanism 15 and the synchronization element 10 are not directly coupled together. The toggle mechanism comprises a first toggle mechanism 15.1, a second toggle mechanism 15.2 and a coupling rod 15.3 which couple the two toggle mechanism 15.1, 15.2 together. The toggle mechanism 15 here couples the door post with the second-fastest door leaf 3.2.

In this exemplifying embodiment the synchronization element 10 comprises two scissors linkages 10.1, 10.3 arranged in mirror image to one another, wherein one is arranged in the upper region of the sliding door 1 and one in the lower region of the sliding door 1. Here the drive shaft 8 is arranged at the upper scissors linkage 10.1. Depending on the respective design of the sliding door 1 and of the synchronization element 10 or the toggle mechanism 15, two scissors linkages 10.1, 10.3 arranged in mirror image to one another can suffice in order to impart sufficient stability to the door leaves 3.1, 3.2, 3.3, 3.4, 3.5.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. We therefore claim as our invention all that comes within the scope and spirit of these claims.

We claim:

1. A sliding door for an elevator installation, the sliding door comprising:
a plurality of door leaves, the door leaves being horizontally displaceable between a closed position and an open position;
a synchronization element coupled to the door leaves, the synchronization element being configured to guide the door leaves at different respective speeds between the closed position and the open position, the synchronization element comprising at least one scissors linkage; and
at least one toggle mechanism coupling a door post with one of the plurality of door leaves, the coupled one of the plurality of door leaves being not arranged directly at the door post.

2. The sliding door of claim 1, the coupled one of the plurality of door leaves being a fastest door leaf.

3. The sliding door of claim 1, the at least one toggle mechanism comprising first and second toggle mechanisms.

4. The sliding door of claim 3, the first and second toggle mechanisms being coupled together by a coupling rod.

5. The sliding door of claim 1, the at least one toggle mechanism comprising a joint, the joint being in a higher position when the sliding door is in the open position and in a lower position when the sliding door is in the closed position.

6. The sliding door of claim 1, the synchronization element comprising at least one first scissors linkage.

7. The sliding door of claim 6, each of the plurality of door leaves being rotatably coupled to the at least one first scissors linkage, the at least one first scissors linkage comprising a free joint between two fulcra.

8. The sliding door of claim 6, the synchronization element further comprising at least one second scissors linkage, the at least one first scissors linkage and the at least one second scissors linkage being arranged in mirror image to each other.

9. The sliding door of claim 6, the at least one first scissors linkage and the at least one toggle mechanism having at least one common fulcrum.

10. The sliding door of claim 6, the at least one first scissors linkage and the at least one toggle mechanism lacking a common fulcrum.

11. The sliding door of claim 6, the at least one first scissors linkage being drivable by a drive shaft.

12. The sliding door of claim 1, the synchronization element comprising a first scissors linkage and a second scissors linkage, the first scissors linkage being arranged in an upper region of the sliding door and the second scissors linkage being arranged in a lower region of the sliding door.

13. The sliding door of claim 1, the at least one toggle mechanism being drivable by a drive shaft.

14. The sliding door of claim 1, the plurality of door leaves comprising a fastest door leaf, the fastest door leaf being suspended by a guide apparatus at a guide rail, the other door leaves of the plurality of door leaves not being suspended by the guide apparatus.

15. A method for a sliding door of an elevator installation, the method comprising:
horizontally displacing a plurality of door leaves between a closed position and an open position using a synchronization element coupled with the plurality of door leaves, the synchronization element comprising at least one scissors linkage and being configured to guide the door leaves at different respective speeds between the closed position and the open position; and
activating at least one toggle mechanism coupling a door post with one of the plurality of door leaves, the coupled one of the plurality of door leaves being not arranged directly at the door post.

16. A sliding door for an elevator installation, the sliding door comprising at least two door leaves which are horizontally displaceable between a closed position and an open position, and a synchronization element, which is coupled with the door leaves and so synchronizes these that the door leaves are guided at different speeds, which are constant relative to one another, in an opening direction from the closed position to the open position and conversely against the opening direction, the sliding door comprising at least one toggle mechanism which couples a door post with only one door leaf, which is not directly arranged at the door post.
